(19) United States
(12) Patent Application Publication
(10) Pub. No.: US 2019/0155517 A1
(43) Pub. Date: May 23, 2019

(54) METHODS AND APPARATUS FOR MEMORY CONTROLLER DISCOVERY OF VENDOR-SPECIFIC NON-VOLATILE MEMORY DEVICES

(71) Applicant: Western Digital Technologies, Inc., San Jose, CA (US)

(72) Inventors: Prabakaran Chinnamaharajan, Bangalore (IN); Karthik Pichandi, Bangalore (IN)

(21) Appl. No.: 15/820,070

(22) Filed: Nov. 21, 2017

(51) Int. Cl. G06F 3/06; G06F 9/4401

(52) U.S. Cl. CPC G06F 3/0611; G06F 3/0679; G06F 3/0653; G06F 9/4401; G06F 3/0634

(57) ABSTRACT

The present disclosure, in various embodiments, describes technologies and techniques for use by a non-volatile memory (NVM) controller to discover an NVM device, such as an NAND device. In an illustrative example, the NVM controller obtains a bypass discovery sequence from a first component of the NVM device using the NVM controller, where the first component may be bootstrap memory. The NVM controller then applies the bypass discovery sequence to a second component of the NVM device, such as a non-captive or reclaim memory component, to access the second component of the NVM device. In this manner, the NVM controller need not rely on pre-stored ROM discovery sequences to discover non-captive NVM memory components that require vendor-specific bypass discovery sequences.

### FIELD

The present disclosure, in various embodiments, relates to non-volatile memory (NVM) devices and memory controllers for use therewith. More specifically, the present disclosure relates to the efficient discovery of vendor-specific NVM devices such as NANDs.

### INTRODUCTION

Solid state data storage devices incorporating non-volatile memories (NVMs), such as flash NAND memories, are replacing or supplementing conventional rotating hard disk drives for mass storage in many consumer electronics and computers. In NAND-based products, a host device such as a videocamera or other portable electronic device includes an NVM device controller for accessing the NAND device. The NVM device controller typically needs to discover the NAND device before the NAND device can be accessed by the host device, where “discovery” refers to a procedure whereby the NVM device controller issues commands in an attempt to access and initialize the NAND device, and the NAND device responds appropriately. If an appropriate response is not received by the NVM device controller, the NAND device is thus not discovered and cannot be accessed by the host device.

In some specific examples, the NVM device controller discovers the NAND device by issuing a NAND ID command 90 or a suitable predetermined Backup ID sequence or protocol. However, there are at least some vendor-specific custom NANDs (e.g. non-captive NANDs) that require specific bypass command sequences or protocols to enable the response/interface from the NAND device. That is, the NAND discovery commands may be a series of specific commands unique to a particular manufacturer's NAND device design and thus may be vendor specific. Herein, a “non-captive” NAND is a NAND device that is designed and manufactured by a third party separate from the company that designs and manufactures the NVM device controller, and hence the designers of the NVM device controller have no control over the particular discovery sequence required by the non-captive NAND device.

Conventionally, various NAND discovery sequences including backup and vendor-specific sequences are implemented in Read Only Memory (ROM) within the NVM device controller. That is, the NVM device controller includes the unique NAND discovery sequence for each NAND device that it expects to interface with during operation of the host device and, if the NAND discovery sequence for a particular NAND device inserted into (or installed within) the host device is not stored in ROM in the NVM device controller, that particular NAND device cannot be accessed by the host device. So, for an example where the NAND device is a detachable flash memory, the host device rejects or ignores the NAND device when it is inserted into the host device because the vendor-specific discovery sequence for that particular flash memory is not pre-stored in the ROM of the NVM device controller.

As such, in order to accommodate or otherwise initialize a new non-captive NAND device, the ROM of the NVM controller typically needs to be recoded or otherwise modified to store the vendor-specific discovery sequence for the new NAND, i.e. a new ROM tape out is required for the NVM controller, which can be expensive and time-consuming for the manufacturer of the NVM controller. Also, any existing NVM controllers without the updated ROM cannot access the new NAND device, frustrating the consumer.

It would be advantageous to address these and other issues, both for NAND devices and for other memory devices such as NOR memory devices.

### SUMMARY

One embodiment of the present disclosure provides a method for operating a non-volatile memory (NVM) controller that is configured to communicate with an NVM device. In one example, the method comprises: obtaining discovery information from a first component of the NVM device using the NVM controller; and applying the discovery information to a second component of the NVM device to access the second component of the NVM memory.

Another embodiment of the present disclosure provides an NVM controller, configured to communicate with an NVM device, comprising: a discovery sequence access controller configured to obtain discovery information from a first component of the NVM device; and a processing component configured to apply the discovery information to a second component of the NVM device to access the second component of the NVM memory.

Yet another embodiment of the present disclosure provides an NVM device, comprising: a first component accessible by a separate NVM controller and configured to store an NVM discovery sequence for use by the NVM controller; and a second component accessible by the NVM controller using the discovery information stored in the first component.

Still yet another embodiment of the present disclosure provides an apparatus for use with an NVM device, comprising: means for obtaining discovery information from a first component of the NVM device; and means for applying the discovery information to a second component of the NVM device to access the second component of the NVM device.

### BRIEF DESCRIPTION OF THE DRAWINGS

A more particular description is included below with reference to specific embodiments illustrated in the appended drawings. Understanding that these drawings depict only certain embodiments of the disclosure and are not therefore to be considered to be limiting of its scope, the disclosure is described and explained with additional specificity and detail through the use of the accompanying drawings, in which:

FIG. 1 illustrates an exemplary configuration of a system with an NVM controller operatively coupled to an NVM device, wherein the NVM controller applies pre-stored discovery sequences to the NVM device.

FIG. 2 illustrates an exemplary process for use by an NVM controller operatively coupled to an NVM device, wherein the NVM controller applies pre-stored discovery sequences to the NVM device.

FIG. 3 provides an overview of an exemplary configuration of an NVM system wherein a suitable vendor-specific bypass discovery sequence is obtained from a bootstrap memory by an NVM controller.

FIG. 4 further illustrates an exemplary configuration of a system with an NVM controller operatively coupled to an NVM device, wherein the NVM controller obtains a vendor-specific discovery sequence from a bootstrap memory in the NVM device.

FIG. 5 illustrates in greater detail an exemplary configuration of a system with an NVM controller operatively coupled to an NVM device, wherein the NVM controller obtains a vendor-specific discovery sequence from the NVM device.

FIG. 6 illustrates in still further detail an exemplary configuration of a system with an NVM controller operatively coupled to an NVM device, wherein the NVM controller obtains a vendor-specific discovery sequence from the NVM device.

FIG. 7 broadly summarizes an exemplary process for use by an NVM controller operatively coupled to an NVM device to access an NVM device.

FIG. 8 further illustrates aspects of an exemplary process for use by an NVM controller operatively coupled to an NVM device to access an NVM device.

FIG. 9 broadly summarizes an exemplary process for use by an NVM device operatively coupled to an NVM controller.

FIG. 10 further illustrates aspects of an exemplary process for use by an NVM device operatively coupled to an NVM controller.

FIG. 11 broadly illustrates an exemplary NVM controller.

FIG. 12 broadly illustrates an exemplary NVM device.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Aspects of the present disclosure provide various apparatus, devices, systems and methods for obtaining discovery information such as discovery sequences from NVM devices, especially non-captive NVM devices with vendor-specific discovery sequences. While the present disclosure will focus primarily on NAND memory technology, it should be understood by those skilled in the art that the teachings contained herein are also applicable to other similar forms of NVM. Herein, a discovery sequence may also be referred to as a discovery protocol, an initialization sequence or an initialization protocol. Still other terms might be used in the art to refer to discovery sequences, such discovery codes, discovery procedures or the like.

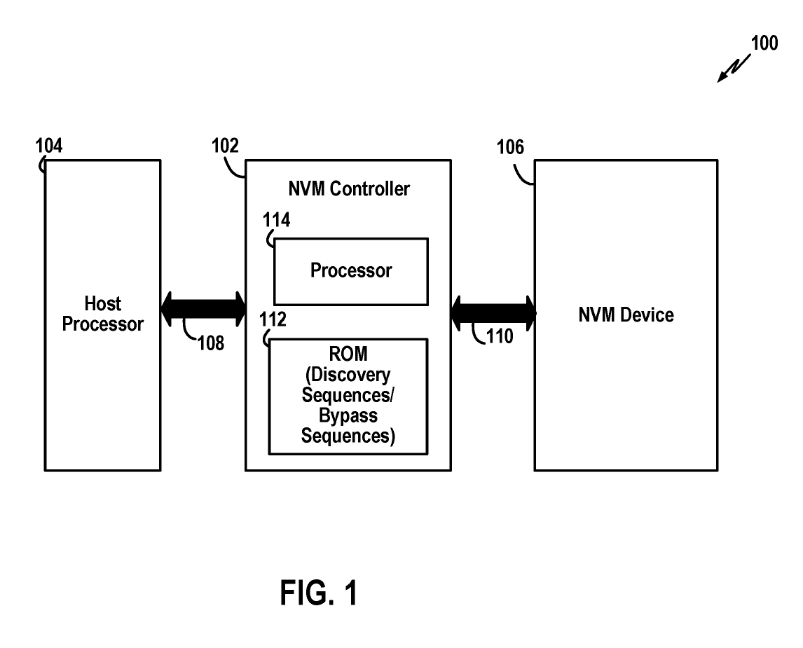

FIG. 1 illustrates an embodiment of an NVM system 100 that includes an NVM controller 102 coupled between a host processor 104 and an NVM device 106 such as a NAND device. The NVM controller 102 is advantageously used by the host processor 104 to access the NVM device 106. While it is possible for an NVM device to be directly accessed by a host processor with no intervening NVM controller, such an architecture is not ideal. The host processor would typically need to individually control each of the NVM device control signals, which can be cumbersome and time-consuming for the host processor. Also, support for Error Detection Codes (EDC) and Error Correction Codes (ECC), often needed when using an NVM device, could put a severe burden on the host processor, i.e. parity bits may need to be calculated for each page written, and error detection calculations (and sometimes also error correction calculations) may need to be performed by the host processor. All this makes a direct access architecture relatively slow and inefficient and warrants the use of an NVM controller such as NVM controller 102 of FIG. 1, which may serve to greatly simplify the tasks of the host processor 104 when using the NVM device 106.

In the example of FIG. 1, the host processor 104 interacts with the NVM controller 102 via a host interface 108 using an interface protocol, where a request for writing a page may be sent as a single command code followed by address and data, instead of requiring the host processor to undergo complex sequencing of control lines and NVM device command codes. The NVM controller 102 converts the host-controller protocol signals into the equivalent NVM device protocol sequences, while the host processor is free to perform other tasks (or wait for the NAND operation to complete, if so programmed). The NVM device protocol sequences generated by the NVM controller 102 are applied to the NVM device 106 via an NVM device interface 110. In use, data read from the NVM device 106 is relayed by the NVM controller 102 to the host processor 104 along interface 108. Data to be written to the NVM device 106 is relayed by the NVM controller 102 from the host processor 104 along interface 110.

In some implementations (not shown in FIG. 1), the NVM controller 102 is physically located or installed within the host processor 104. For example, if the host processor is implemented as a single die, the NVM controller 102 may be incorporated on the same die. This technique is used, for example, in Open Multimedia Applications Platform (OMAP) processors. In a system with this architecture, the host processor 104 typically interacts with the NVM controller 102 using a proprietary protocol, as the interaction is internal to the host processor and there is little or no benefit in using a standard protocol.

Alternatively, as shown in FIG. 1, NVM controller 102 may be configured as a separate physical element coupled between the host processor 104 and the NVM device 106. This architecture is used, e.g., in portable Universal Serial Bus (USB) Flash Drives (UFDs), where NVM controller 102 may be packaged inside the UFD and interacts using a device-side NVM interface with the NVM device 106 on one side and with the host processor 104 on the other side (e.g., using a host-side USB interface with USB protocol). In a system using such an architecture, the host processor 104 typically interacts with the NVM controller 102 using a standard protocol such as USB or Advanced Technology Attachment (ATA), as the interaction is external to the processor and it is thus more convenient to use standard protocols that are already supported by the processor for other purposes. Still further, in other examples, the NVM controller 102 may be physically located within the NVM device 106 as a component thereof. See, for example, mobile disk on chip (mDOC) storages devices. In a system with this architecture, the host processor 104 typically interacts with the NVM controller 102 using either a standard protocol such as USB or a semi-standard protocol as is the case in the mDOC.

As shown in FIG. 1, the NVM controller 102 may include a ROM 112 that stores discovery sequences for use in discovering one or more memory components within the NVM device 106 to enable (or permit) the host processor 104 to then access the NVM device 106. As noted above, discovery refers to a procedure whereby an NVM controller issues commands in an attempt to access/initialize an NVM device. If an appropriate response is not received by the NVM controller, the NVM device is thus not discovered and cannot be accessed by the host processor. In the example of FIG. 1, the NVM controller 102 includes a processor 114 that, among other functions, reads one or more discovery sequences (or other bypass sequences) from the ROM 112, applies the sequences to the NVM device 106, and processes any response to set up or initialize the NVM device so it may be read from/written to by the host processor 104. (Herein, a bypass sequence is considered to be one type of a discovery sequence.)

Problems can arise if the NVM device 106 is a non-captive (or reclaim) memory device with a vendor-specific discovery sequence. If a vendor-specific discovery sequence is required but not stored in the ROM 112, the NVM device 106 may not be discoverable. To address this problem and in one example, NVM controller 102 may be configured to obtain a discovery sequence from a first component of the NVM device 106 using the NVM controller, and apply the discovery sequence to a second component of the NVM device to access the second component of the NVM device, thereby allowing NVM device 106 to be discovered.

Exemplary discovery sequences for use with NVM devices are described in Open NAND Flash Interface Specification, Revision 4.0, dated Apr. 2, 2014. The sequences may depend, for example, on whether independent single or dual/quad data buses are provided with the NVM device. Briefly, in an example where a single bus (not shown in FIG. 1) is used, a “CE_n to test” signal is pulled low by the NVM controller 102 to enable an NVM device 106, if connected, while all other CE_n signals are pulled high. (The CE_n signals are not shown in FIG. 1.) The controller 102 then issues a Reset command to the NVM device 106. Following the reset, the NVM controller 102 issues a Read ID command to the NVM device 106. If a predetermined signature is returned by the Read ID command with a certain address (e.g. 20h), the NVM device 106 is thus connected, i.e. discovered. For an ONFI implementation, the predetermined signature may be a unique ONFI signature that is the ASCII encoding of ‘ONFI’ where ‘O’=4Fh, ‘N’=4Eh, ‘F’=46h, and ‘I’=49h. If the predetermined signature is not returned by NVM device 106 or any step in the process encounters an error/timeout, CE_n is not connected and the NVM device is thus not discovered by the NVM controller.

In an example where a dual or quad bus (not shown) is employed, the “CE_n to test” is first pulled low by the NVM controller 102 to enable the target if connected, while all other CE_n signals are pulled high. The NVM controller 102 then issues a Reset (e.g. FFh) command to the NVM device 106. Following the reset, the NVM controller 102 issues a Read ID command with a certain address (e.g. 20h) to the target. If the predetermined signature is returned by the Read ID command, the NVM device 106 is thus connected (i.e. discovered). If the predetermined signature is not returned by the NVM device 106 (or any step in the process encountered an error/timeout), a second 8-bit data bus is then probed. The NVM controller 102 issues the Reset (e.g. FFh) command to the NVM device 106 using the second 8-bit data bus. Following the reset, the NVM controller 102 then issues a Read ID command with address 20h to the NVM device 106 on the second 8-bit data bus. If the predetermined signature is returned by the Read ID command, the NVM device 106 is connected (i.e. discovered) and on the second 8-bit data bus. After discovering that the NVM device 106 is using the second 8-bit data bus, all subsequent commands to the NVM device 106 use the second 8-bit data bus including, e.g., a Read Parameter Page. If the predetermined signature is not returned for the second 8-bit data bus, the discovery process just described for the second 8-bit data bus is repeated for the third and fourth 8-bit data busses. If no valid signature is returned or further errors are encountered, the CE_n is not connected and the NVM device 106 is thus not discovered by the NVM controller 102. Additional variations in discovery may be used if CE_n pin reduction techniques are employed, as described in the Open NAND Flash Interface Specification.

Since the standard Open NAND protocols are often used, the aforementioned discovery sequence may be stored in ROM 112 so that any NVM device utilizing the Open NAND protocol can be easily discovered. However, for non-captive devices, the discovery sequence or protocol that is required may differ from the Open NAND sequence by, for example, using a different predetermined signature or ID, or a different sequence of commands.

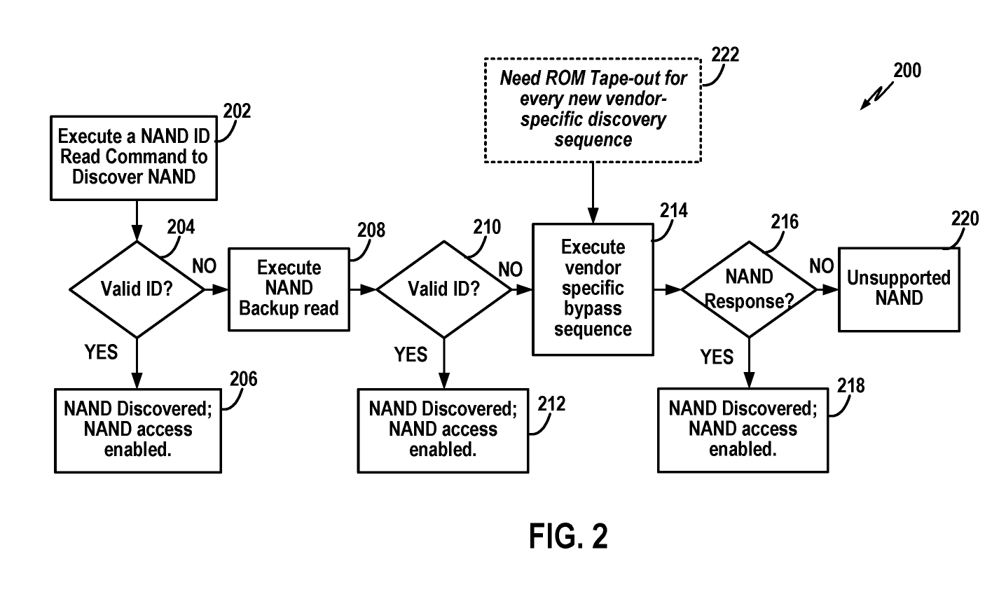

FIG. 2 provides an overview of an exemplary NVM discovery process 200 for use in a system where the NVM device is a NAND. At 202, a NAND ID read command is executed by an NVM controller that is physically connected to the NAND in an attempt to discover the NAND (i.e. an initial standard discovery sequence of the type described above is applied to the NAND to obtain a predetermined signature, i.e. a valid ID). If, at 204, a valid ID is returned by the NAND, the NAND is thereby discovered, at 206, and access to the NAND is enabled. If no valid ID was returned by the NAND at 204, i.e. the standard discovery sequence is not recognized by the NVM device, the NVM controller executes a NAND backup read, at 208, in a second attempt to discover the NAND, i.e. a backup discovery sequence is applied to the NAND. (A backup sequence might be, e.g., a discovery sequence defined by a different standards body using a different series of commands.) Again, if a valid ID is returned by the NAND, at 210, the NAND is thereby discovered, at 212, and access to the NAND is enabled.

If no valid ID is again returned by the NAND at 210, the NVM controller then executes a vendor-specific bypass sequence, at 214, in a further attempt to discover the NAND, i.e. a vendor-specific discovery sequence is obtained from the ROM (112 of FIG. 1) of the NVM controller (102 of FIG. 1) and applied to the NAND NVM device. If a NAND ID or other appropriate response is received from the NAND, at 216, the NAND is thereby discovered, at 218, and access to the NAND is enabled. If not, the NAND is deemed to be unsupported, at 220. Although not shown in FIG. 2, the ROM of the NVM controller may store numerous vendor-specific bypass discovery sequences, which may be applied in turn to the NAND in an effort to discover the NAND, with the NAND deemed unsupported only if none of the vendor-specific sequences is found to trigger the appropriate response from the NAND.

As shown by way of dashed block 222, a new ROM tape-out is typically required for every new vendor-specific discovery sequence that the NVM controller needs to access. That is, in order to accommodate the use of a newly designed NAND component provided by a third-party vendor (e.g. to accommodate a new non-captive or reclaim NAND memory component), the appropriate vendor-specific discovery sequence for the new NAND component typically needs to be obtained from the vendor and stored in the ROM of the NVM controller. This requires modifying the ROM, which in turn requires a new tape out (where “tape-out” is the final result of the design process for ROM-based NVM controllers before they are sent for manufacturing). Such an iterative re-design may also be referred to as a “re-spin” or “re-spinning” the ROM, and can be costly for the NVM controller manufacturer.

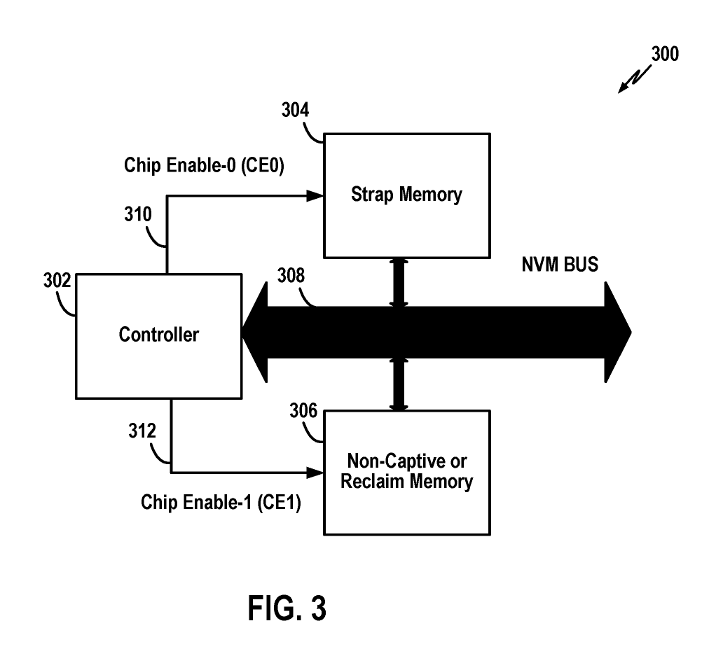

FIG. 3 provides an overview of an embodiment of a modified NVM system 300 that includes an controller 302 coupled between a host processor (not shown) and an NVM device that includes a strap memory 304 (i.e. bootstrap memory) and a non-captive or reclaim memory 306. The non-captive memory 306 might include a NAND or other NVM device such as a NOR device. The controller 302 and the components of the NVM device are connected via an NVM bus 308 (which is connected to both the strap memory 304 and the non-captive or reclaim memory 306 as shown). The strap memory 304 is also accessible by the controller 302 via a CE0 chip enable line 310. The non-captive/reclaim memory 306 is accessible by the controller 302 via a CE0 chip enable line 312. That is, with this configuration, the strap memory 304 is interfaced with the controller 302 on CE0 and the vendor-specific NVM is interfaced with the controller 302 on CE1. The strap memory 304 may have a short boot strapping code. The controller 302 detects/initializes the strap memory and loads the bootstrap, which contains the appropriate discovery sequence for the non-captive memory 306. To implement this system, the strap memory should be compatible with the controller and have at least a few valid blocks to store the appropriate bootstrap code.

In use, the controller 302 asserts the CE0 and obtains a by-pass sequence stored in the bootstrap memory 304. The controller then asserts the CE1 to apply the by-pass sequence to the non-captive memory 306, which responds to the bypass sequence with an ID or other suitable initialization information, thereby allowing the controller 302 to discover the NVM device. After this initialization procedure is complete, the non-captive memory 306 on CE1 is then used as the primary memory for main storage. The system/procedure of FIG. 3 may thus be used to avoid the need for controller ROM re-spins for vendor-specific memory devices.

In one example, the bypass discovery sequence obtained from the bootstrap memory 304 specifies the particular sequence of signal lines to be controlled (e.g., pulled high or low), and in what order, and the particular commands that need to be issued (such as RESET commands or READ ID commands), and in what order, and further specifies any unique predetermined signature or ID that needs to be returned. In one specific example, if the ROM within controller 302 does not include the aforementioned Open NAND discovery sequence, and that sequence is needed to access the NVM device, the strap memory 304 of the NVM device would be configured to include the Open NAND discovery sequence, including the Open NAND ID, so that the Open NAND sequence and the Open NAND ID can be obtained by the controller 302 from the strap memory 304 for applying to the non-captive memory 306 (using CE1 and/or any other control lines needed to implement the discovery sequence) to thereby discover the non-captive memory. In a more typical example, the non-captive NVM device might require a particular vendor-specific discovery sequence that is different from the aforementioned Open NAND sequence, and that particular vendor-specific discovery sequence (including any unique signatures or IDs) is stored in the strap memory 304 to provide the controller 302 with the needed sequence to discover and access the NVM device.

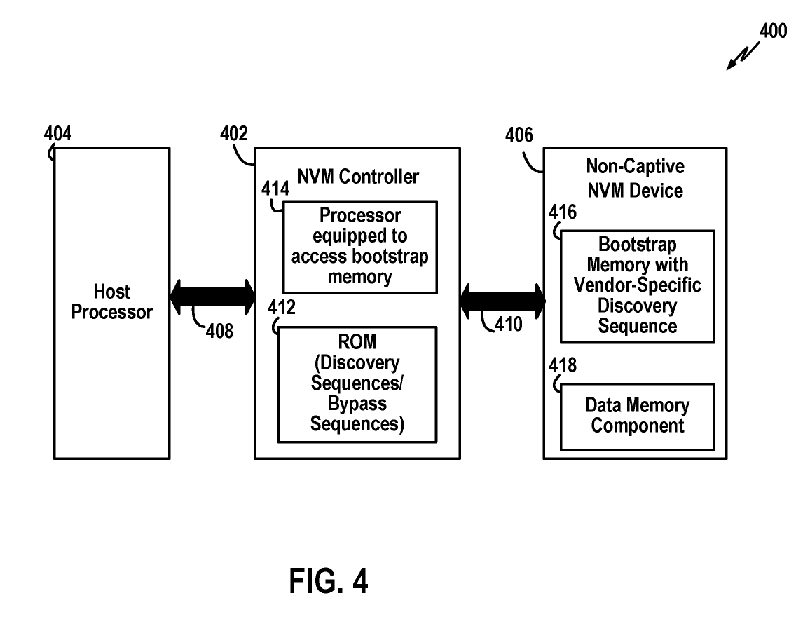

FIG. 4 illustrates in greater detail an exemplary NVM system 400 that includes an NVM controller 402 coupled between a host processor 404 and an NVM device 406. The host processor 404 interacts with the NVM controller 402 via a host interface 408 using an interface protocol, where a request for writing a page may be sent as a single command code followed by address and data. The NVM controller 402 converts the host-controller protocol signals into the equivalent NVM device protocol sequences, at least so long as the NVM device 406 is properly discovered. Once discovered, the NVM device protocol sequences generated by the NVM controller 402 can be applied to the NVM device 406 via an NVM device interface 410. In use, data read from the NVM device 406 is relayed by the NVM controller 402 to the host processor 404 along interface 408. Data to be written to the NVM device 406 is relayed by the NVM controller 402 from the host processor 404 along interface 410.

The NVM controller 402 includes a processor 414 that, among other functions, reads one or more discovery sequences (or bypass sequences) from the ROM 412, applies the discovery sequences to the NVM device 406, and processes any response to set up the NVM device so it may be read from and/or written to by the host processor 404. However, as with FIG. 3, the NVM controller 402 of FIG. 4 is equipped (e.g. configured) to access a bootstrap memory 416 of the NVM device 406 to obtain a vendor-specific discovery sequence. That is, to facilitate discovery of the NVM device 406, which may be a non-captive NVM with reclaim memory, the NVM device 406 includes bootstrap memory 416 that stores the appropriate vendor-specific discovery sequence for the NVM device 406. Once the NVM device 406 is discovered using the vendor-specific discovery sequence, data may be accessed (e.g. written to and/or read from) a data memory component 418 of the NVM device 406.

In one example, the processor 414 is configured to immediately access the bootstrap memory 416 to obtain a discovery sequence for the NVM device 406 (without first using the pre-stored sequences in ROM 412). In other examples, the processor 414 might apply the various pre-stored sequences in its ROM 412 to the NVM device 406 in an attempt to discover the device and then access the bootstrap memory 416 only if none of the pre-stored sequences is effective in discovering the device. In either case, by providing vendor-specific discovery sequences within the NVM device itself, ROM re-spins of the type discussed above are not needed since the ROM of the NVM controller need not be updated to store new vendor-specific discovery sequences for non-captive NVM devices. Rather, those discovery sequences are obtained from the bootstrap memory of the NVM device.

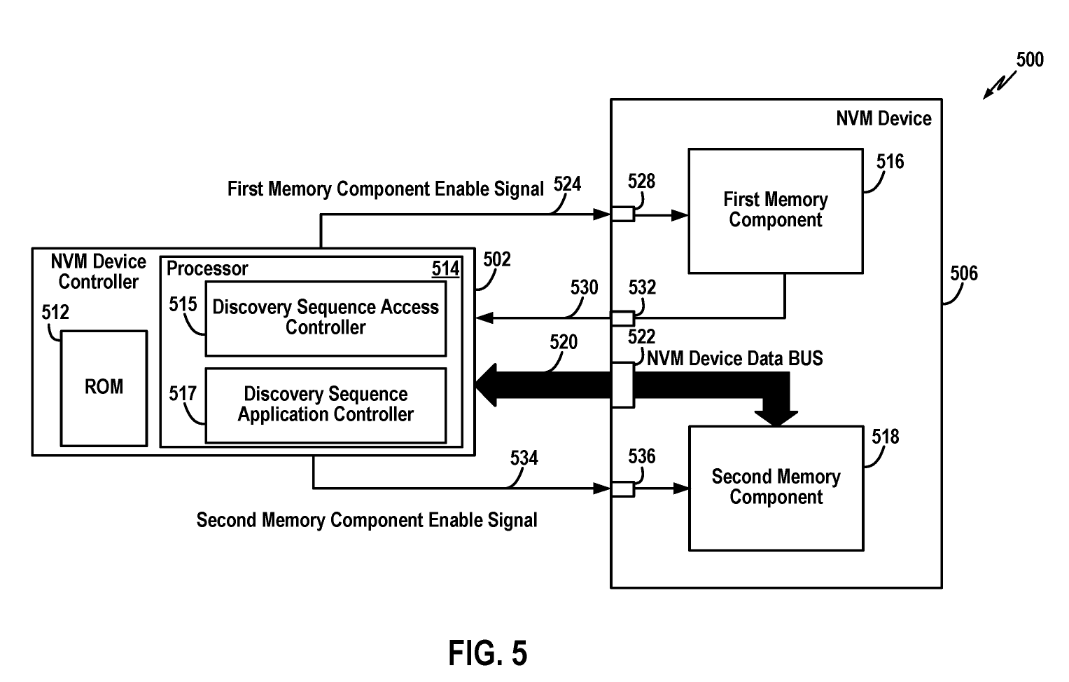

FIG. 5 illustrates in still greater detail an exemplary NVM system 500 that includes an NVM controller 502 and an NVM device 506. The NVM controller 502 includes a processor 514 and a ROM 512. The processor 514 includes a discovery sequence access controller 515 configured to access a first memory component (or portion) 516 of the NVM device 506 to obtain a sequence for that particular NVM device. The processor 514 also includes a discovery sequence application controller 517 configured to apply the sequence obtained from the first memory component 516 to the NVM device 506 to discover the NVM device to enable access to a second memory component 518. Thereafter, the second memory component 518 may be accessed using an NVM device data BUS 520 via one or more terminals 522.

The discovery sequence access controller 515 accesses the first memory component 516 by applying a first memory component enable signal along a line 524 coupled to a terminal 526. The reply (i.e. a discovery sequence for the NVM device) is received along a line 530 via a terminal 532. The discovery sequence application controller 517 applies the sequence via a second memory component enable signal along a connection line 534 via a terminal 536. Thereafter, data may be transferred via NVM device data bus 520. (Depending upon the particular implementation, connection lines 524 and 534 might form part of the bus 520).

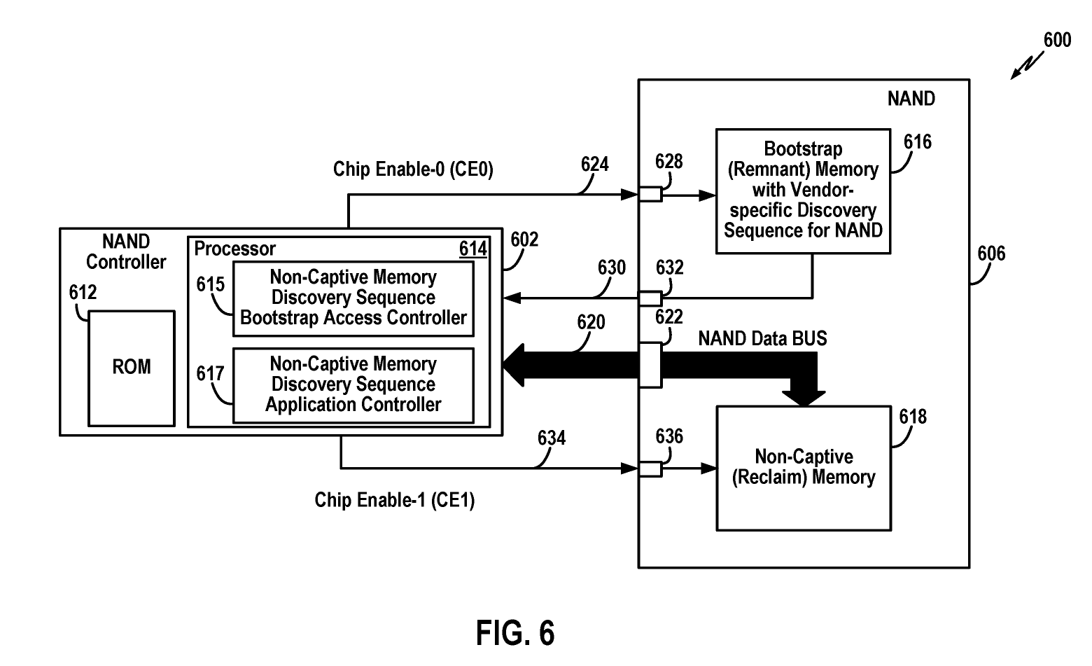

FIG. 6 illustrates in still further detail an NVM system 600. In the NVM system 600 of FIG. 6, the NVM controller is a NAND controller 602 and the NVM device is a NAND 606, which may include non-captive or reclaim memory. The NAND may also be referred to herein as a “NAND Flash memory,” “NAND memory device,” “NAND flash,” or just a “NAND device.” Generally speaking, a NAND is a non-volatile memory having high storage density, fast access time, low power requirements in operation and advantageous shock resistance, compared to more conventional memory platforms. Raw NAND devices, of the type shown in FIG. 6, may be equipped (e.g. configured) with a serial interface such as Open NAND Flash Interface (ONFi), Common Flash Memory Interface (CFI), and the like. NAND devices may be configured as discrete memory chips, as in FIG. 6, or packaged with a controller to form SD memory card, Multi Media Card (MMC) or solid state disk (SSD). NAND 606 may be configured with a single flash die, or a plurality of dies.

In the example of FIG. 6, the NAND controller 602 includes a processor 614 and a ROM 612 for storing pre-stored discovery sequences for captive NAND devices (and any vendor-specific discovery sequences for non-captive NAND devices that are already known at the time the NAND controller is designed and hence can be stored within the ROM at tape out). In the example of FIG. 6, the processor 614 includes a non-captive memory discovery sequence bootstrap access controller 615 that is configured to access a bootstrap (remnant) memory 616 of the NAND 606 to obtain a vendor-specific discovery sequence for that particular NAND. The processor 614 also includes a non-captive memory discovery sequence application controller 617 that is configured to apply the vendor-specific discovery sequence obtained from bootstrap memory 616 to the NAND to discover the NAND to enable access to its non-captive memory 618. Once the NAND 606 is discovered using the vendor-specific discovery sequence, data may be written to and/or read from memory 618 using a NAND data BUS 620 via one or more terminals 622. Note that, although not shown in FIG. 6 the NAND 606 may include various other components, such as control/address logic components, I/O components, and data register components.

In the particular example of FIG. 6, the bootstrap access controller 615 of the processor 614 accesses the bootstrap memory 616 by applying a first chip enable-0 signal along a CE0 connection line 624 coupled to a first terminal 626. The reply (i.e. the vendor-specific discovery sequence for the NAND) is received along a separate line 630 via a terminal 632 but might be received along CE0. (The separate line 630 is shown for the sake of generality.) The discovery sequence application controller 617 applies the vendor-specific discovery sequence to the NAND 606 via a second chip enable-1 signal along a CE1 connection line 634 coupled to a second terminal 636. As noted, once the NAND is discovered, data may be transferred via NAND data BUS 620 in accordance with read or write operations. (Note that, depending upon the particular implementation, the CEO and CE1 lines might form part of the bus 620).

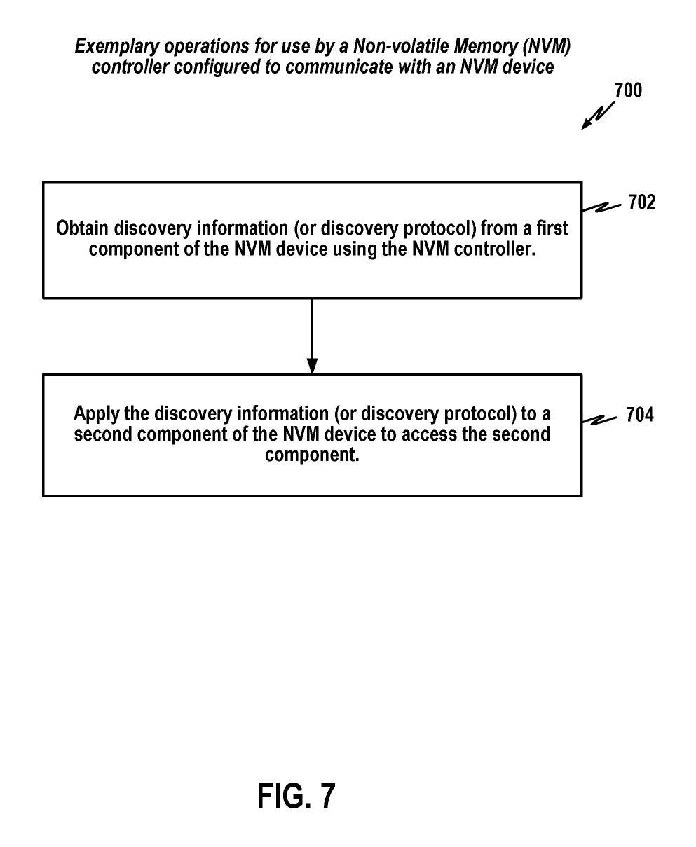

FIG. 7 broadly summarizes exemplary operations 700 for use by an NVM controller configured to communicate with an NVM device. Briefly, at 702, the NVM controller obtains discovery information (e.g. all or at least a portion of a vendor-specific discovery sequence or discovery protocol) from a first component of the NVM device, such as bootstrap memory. At 704, the NVM controller applies the discovery information (or discovery protocol) to a second component of the NVM device to access the second component of the NVM device, which may include non-captive memory. The discovery information may include an entire NVM discovery sequence or just a portion thereof, such as just a NAND ID.

Exemplary discovery sequences are described above. As explained, a particular vendor-specific discovery sequence (including any needed signatures or IDs) may be obtained from an NVM device to provide the controller 302 with the needed information to discover and access the NVM device. Hence, in at least some examples, the discovery sequence obtained from the first component of the NVM specifies a particular sequence of signal lines to be pulled high or low, and in what order, and a particular set of commands to be issued (such as RESET commands or READ ID commands), and in what order, and further specifies any unique predetermined signature or ID that needs to be returned. In some examples, only a portion of an overall discovery sequence is obtained from the first component of the NVM device, such as just a signature or ID, which may then be used a part of an overall discovery sequence. In other examples, an entire discovery sequence, i.e. all of the needed signals, commands, IDs, etc., and the order in which they are applied, are obtained from the first component of the NVM device (e.g. from the bootstrap memory).

In at least some examples, means may be provided for performing the functions illustrated in FIG. 7 and/or other functions illustrated or described herein. For example, an apparatus (e.g. NVM controller 502 of FIG. 5) may be provided for use with an NVM device (e.g. NVM device 506) where the apparatus includes: means for obtaining a discovery sequence from a first component of the NVM device (where the means for obtaining may be, e.g., the discovery sequence access controller 515), and means for applying the discovery sequence to a second component of the NVM device to access the second component of the NVM device (where the means for applying may be, e.g., the discovery sequence application controller 517). The first component of the NVM device may include a bootstrap memory formed of remnant memory (as shown in FIG. 6). The second component of the NVM device may be a non-captive memory component such as a reclaim component (as also shown in FIG. 6). The means for obtaining the discovery information may include means (such as controller 615 of FIG. 6) for obtaining one or more of (a) a particular sequence of signal lines of the NVM device to be controlled, (b) a particular set of commands to be issued to the NVM device, and (c) a predetermined signature or ID associated with the NVM device. The means for applying the discovery information to the second component of the NVM device may include means (such as controller 617 of FIG. 6) for applying one or more of (a) the particular set of commands to be issued to the NVM device and (b) the predetermined signature or ID associated with the NVM device while (c) using the particular sequence of signal lines. The means for obtaining the discovery sequence from the first component of the NVM device may include a means for applying a first chip enable signal to a first terminal of the NVM device (such as CE0 chip enable line 624 of FIG. 6). The means for applying the discovery sequence to the second component of the NVM device may include means for applying a second chip enable signal to a second terminal of the NVM device (such as CE1 chip enable line 634 of FIG. 6). These are just some examples of suitable means.

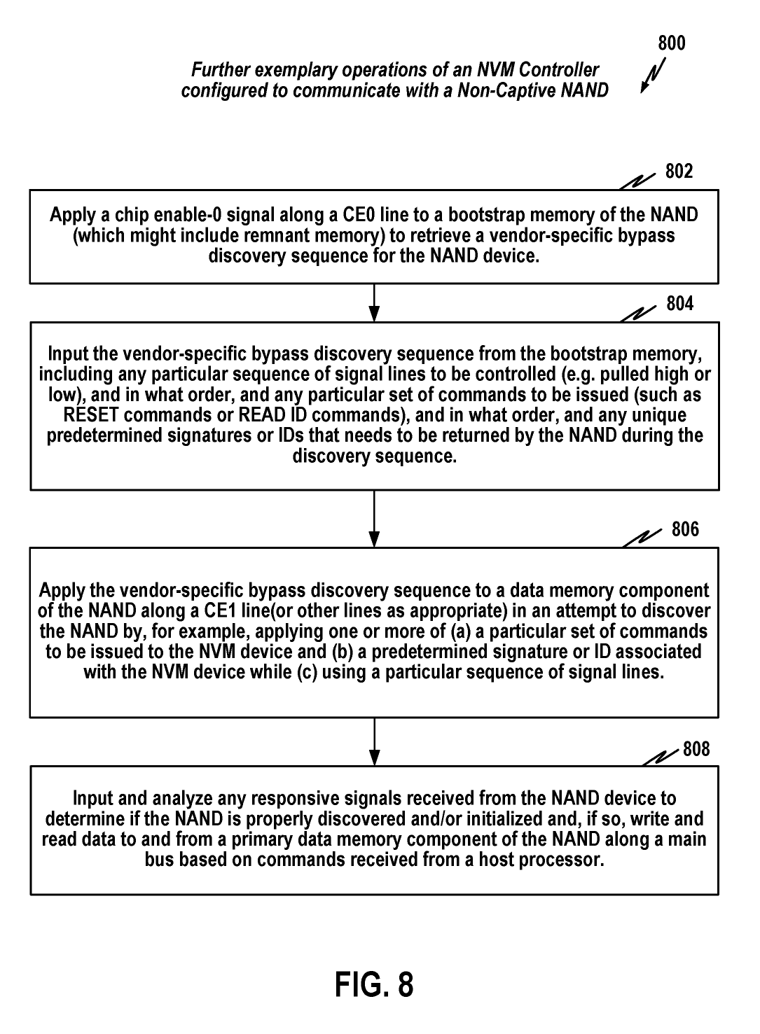

FIG. 8 summarizes further exemplary operations 800 for use with a system where the NVM device is a NAND and where certain specific signal lines are employed. Briefly, at 802, a chip enable-0 signal is applied by the NVM controller along a CE0 line to a bootstrap memory of the NAND (which might include remnant memory) to retrieve a vendor-specific bypass discovery sequence for the NAND device. At 804, the vendor-specific bypass discovery sequence is input by the NVM controller from the bootstrap memory, including any particular sequence of signal lines to be controlled (e.g. pulled high or low), and in what order, and any particular set of commands to be issued (such as RESET commands or READ ID commands), and in what order, and any unique predetermined signatures or IDs that needs to be returned by the NAND during the discovery sequence. At 806, the vendor-specific bypass discovery sequence is applied by the NVM device to a data memory component of the NAND along a CE1 line (or other lines as appropriate) in an attempt to discovery the NAND by, for example, applying one or more of (a) a particular set of commands to be issued to the NVM device and (b) a predetermined signature or ID associated with the NVM device while (c) using a particular sequence of signal lines. At 808, any responsive signals received from the NAND are input and analyzed by the NVM controller to determine if the NAND is properly discovered and/or initialized and, if so, the NVM controller writes and reads data to and from the data memory component of the NAND along a main bus based on commands received from a host processor.

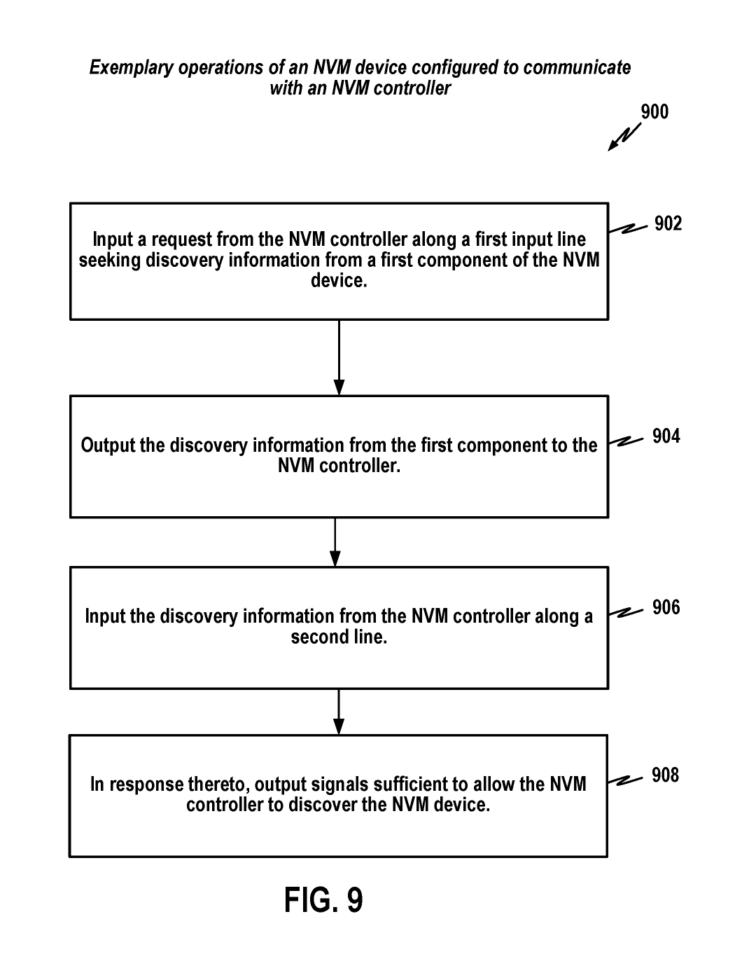

FIG. 9 broadly summarizes exemplary operations 900 for use by an NVM device configured to communicate with an NVM controller. Briefly, at 902, the NVM device inputs a request from the NVM controller along a first input line seeking discovery information (such as all or a portion of a discovery sequence) from a first component of the NVM device. At 904, the NVM device outputs the discovery information from the first component to the NVM controller. At 906, the NVM device inputs the discovery information from the NVM controller along a second line. At 908, in response thereto, the NVM device outputs signals sufficient to allow the NVM controller to discover the NVM device.

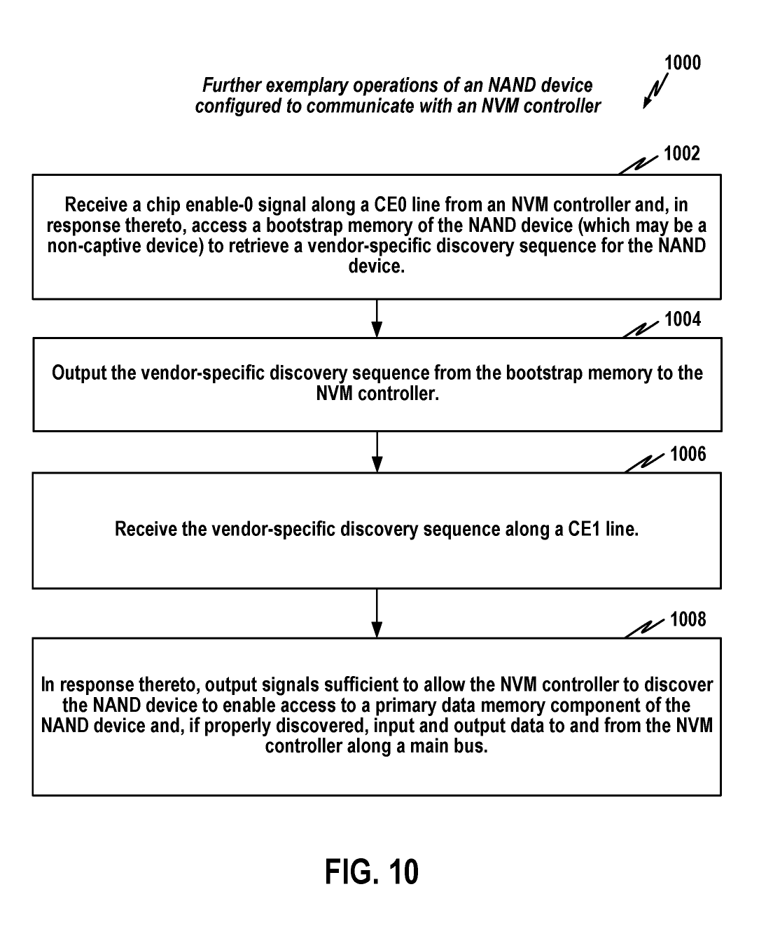

FIG. 10 summarizes further exemplary operations 1000 for use with a system where the NVM device is a NAND and where certain specific signal lines are employed. Briefly, at 1002, the NAND device receives a chip enable-0 signal along a CE0 line from an NVM controller and, in response thereto, accesses a bootstrap memory of the NAND device (which may be a non-captive device) to retrieve a vendor-specific discovery sequence for the NAND device. At 1004, the NAND device outputs the vendor-specific discovery sequence from the bootstrap memory to the NVM controller. At 1006, the NAND device receives the vendor-specific discovery sequence along a CE1 line. At 1008, in response thereto, the NAND device outputs signals sufficient to allow the NVM controller to discover the NAND device to enable access to a primary data memory component of the NAND device and, if properly discovered, input and output data to and from the NVM controller along a main bus.

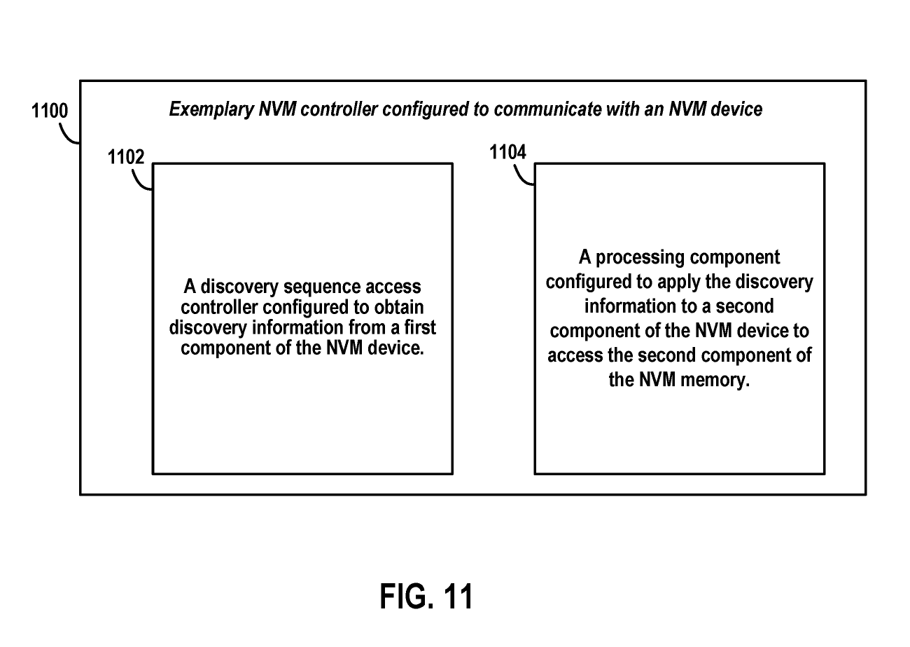

FIG. 11 broadly illustrates an exemplary NVM controller 1100 for use by an NVM device. Briefly, the NVM controller 1100 includes a discovery sequence access controller 1102 configured to obtain discovery information from a first component of the NVM device; and a processing component 1104 configured to apply the discovery information to a second component of the NVM device to access the second component of the NVM memory. As discussed above, the NVM device may include non-captive NAND, the discovery sequence access controller 1102 may access a bootstrap memory of the NAND to obtain a vendor-specific discovery bypass sequence, and the processing component 1104 may then apply the vendor-specific discovery bypass sequence to a primary memory component of the NAND.

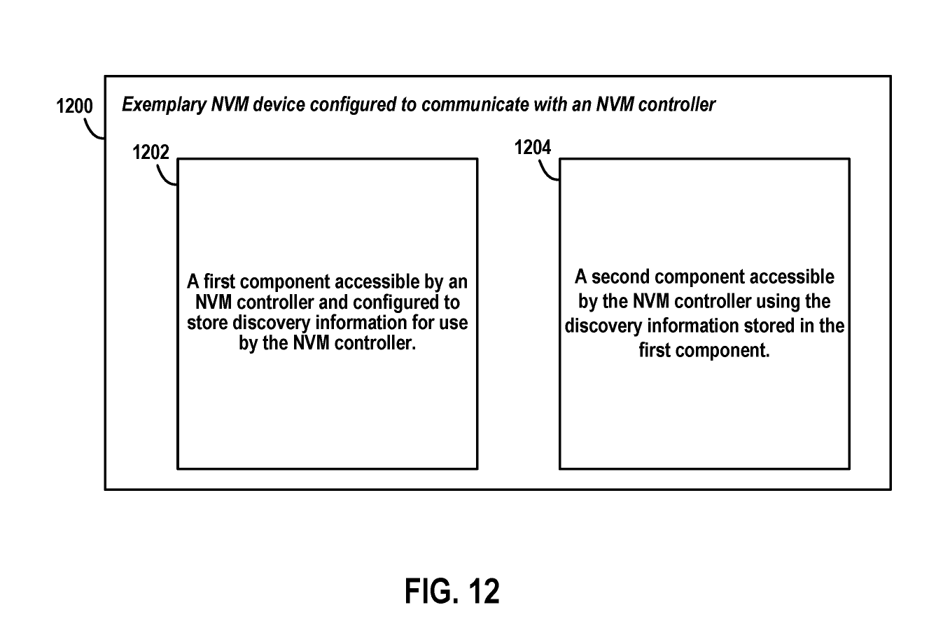

FIG. 12 broadly illustrates an exemplary NVM device 1200 for use by an NVM controller. Briefly, the NVM device 1200 includes a first component 1202 accessible by an NVM controller and configured to store discovery information for use by the NVM controller; and a second component 1204 accessible by the NVM controller using the discovery information stored in the first memory component. As discussed above, the NVM device may be a NAND, the first component may be a bootstrap memory, and the second component may be a primary data memory component, such as a non-captive memory.

While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

1. A method of operating a non-volatile memory (NVM) controller configured to communicate with an NVM device, comprising:
obtaining discovery information from a first component of the NVM device using the NVM controller, wherein the NVM device is configured for read access and write access; and
applying the discovery information to a second component of the NVM device to access the second component of the NVM device.

2. The method of claim 1, wherein the NVM device is a flash memory, and wherein the discovery information is flash discovery information.

3. The method of claim 2, wherein the discovery information comprises a flash discovery sequence.

4. The method of claim 1, wherein obtaining the discovery information from the first component of the NVM device using the NVM controller comprises obtaining one or more of (a) a particular sequence of signal lines of the NVM device to be controlled, (b) a particular set of commands to be issued to the NVM device, and (c) a predetermined signature or identification (ID) associated with the NVM device.

5. The method of claim 4, wherein applying the discovery information to the second component of the NVM device comprises applying one or more of (a) the particular set of commands to be issued to the NVM device and (b) the predetermined signature or ID associated with the NVM device while (c) using the particular sequence of signal lines.

6. The method of claim 1, wherein the first component of the NVM device comprises a bootstrap memory.

7. The method of claim 6, wherein the bootstrap memory of the NVM device comprises remnant memory.

8. The method of claim 1, wherein the second component of the NVM device comprises a non-captive memory component.

9. The method of claim 1, wherein the NVM device is a NAND device.

10. A non-volatile memory (NVM) controller configured to communicate with an NVM device, comprising:
a discovery information access controller configured to obtain discovery information from a first memory component of the NVM device, wherein the NVM device is configured for read access and write access; and
a discovery information application controller configured to apply the discovery information to a second memory component of the NVM device to access the second component of the NVM device.

11. The NVM controller of claim 10, wherein the NVM device is a flash memory, and wherein the discovery information is flash discovery information.

12. The NVM controller of claim 11, wherein the discovery information comprises a flash discovery sequence.

13. The NVM controller of claim 10, wherein the discovery information access controller is further configured to obtain the discovery information from the first component of the NVM device by obtaining one or more of (a) a particular sequence of signal lines of the NVM device to be controlled by the NVM controller, (b) a particular set of commands to be issued to the NVM device by the NVM controller, and (c) a predetermined signature or ID associated with the NVM device.

14. The NVM controller of claim 13, wherein the discovery information application controller is further configured to apply the discovery information to the second component of the NVM device by applying one or more of (a) the particular set of commands to be issued to the NVM device and (b) the predetermined signature or ID associated with the NVM device while (c) using the particular sequence of signal lines.

15. The NVM controller of claim 10, wherein the first memory component of the NVM device comprises a bootstrap memory.

16. The NVM controller of claim 15, wherein the bootstrap memory of the NVM device comprises remnant memory.

17. The NVM controller of claim 10, wherein the second memory component of the NVM device comprises a non-captive memory component.

18. The NVM controller of claim 10, wherein the NVM device comprises a NAND device.

19. A non-volatile memory (NVM) device, comprising:
a first component accessible by an NVM controller and configured to store discovery information for use by the NVM controller; and
a second component accessible by the NVM controller using the discovery information stored in the first component, wherein the NVM device is configured for read access and write access.

20. The NVM device of claim 19, wherein the NVM device is a flash memory.

21. The NVM device of claim 20, wherein the discovery information comprises a flash discovery sequence.

22. The NVM device of claim 19, wherein the first component is configured to store one or more of (a) a particular sequence of signal lines of the NVM device to be controlled by the NVM controller, (b) a particular set of commands to be issued to the NVM device by the NVM controller, and (c) a predetermined signature or ID associated with the NVM device.

23. The NVM device of claim 19, further comprising:
one or more first terminals configured to enable the NVM controller to obtain the discovery information from the first component; and
one or more second terminals configured to enable the NVM controller to access the second component using the discovery information obtained from the first component.

24. The NVM device of claim 19, wherein the first component of the NVM device comprises a bootstrap memory.

25. The NVM device of claim 24, wherein the bootstrap memory of the NVM device comprises remnant memory.

26. An apparatus for use with a non-volatile memory (NVM) device, comprising:
means for accessing discovery information from a first memory component of the NVM device, wherein the NVM device is configured for read access and write access; and
means for applying the discovery information to a second memory component of the NVM device to access the second memory component of the NVM device.

27. The apparatus of claim 26, wherein the NVM device is a flash memory.

28. The apparatus of claim 27, wherein the discovery information comprises a flash discovery sequence.

29. The apparatus of claim 26, wherein the means for accessing the discovery information from the first component of the NVM device comprises means for obtaining one or more of (a) a particular sequence of signal lines of the NVM device to be controlled, (b) a particular set of commands to be issued to the NVM device, and (c) a predetermined signature or ID associated with the NVM device.

30. The apparatus of claim 29, wherein the means for applying the discovery information to the second component of the NVM device comprises means for applying one or more of (a) the particular set of commands to be issued to the NVM device and (b) the predetermined signature or ID associated with the NVM device while (c) using the particular sequence of signal lines.
